(19) United States
(12) Patent Application Publication
(10) Pub. No.: US 2004/0243458 A1
(43) Pub. Date: Dec. 2, 2004

(54) Method and system for organization management utilizing document-centric intergrated information exchange and dynamic data collaboration

(76) Inventor: Lior Barkan, Tel Aviv (IL)

Correspondence Address: FOLEY AND LARDNER, SUITE 500, 3000 K STREET NW, WASHINGTON, DC, 20007, US

(21) Appl. No.: 10/483,268

(22) PCT Filed: Jul. 17, 2001
(86) PCT No.: PCT/IL01/00656

(51) Int. Cl. G06F 17/60

(52) U.S. Cl. 705/9

(57) ABSTRACT

One aspect of the present invention regards a computer-based organization management method for the establishment, systematic and creative building, integration, distribution, sharing, and controlling of information operative in the management of an organization. The method includes the steps of generating at least one document template on the computer readable media for the storage of the at least one organized and formatted organization information unit concerning the structure and functionality of the organization, and creating at least one procedure document based on the at least one organized and formatted organization information unit stored in the at least one document template established on the computer-readable media.

### BACKGROUND OF THE INVENTION

1. Field of the Invention

The present invention generally relates to the field of organization management. More specifically, the present invention relates to a computer-based management system and a method operative in the creation, integration, distribution, and sharing of document-based information in order to support analysis, visualization, decision-making, control, and coordination in an organization.

2. Discussion of the Related Art

Management systems are computing systems comprising software tools designed and developed for automating aspects of management in an enterprise in order to provide information about the business operations. Management systems are operative in the support of the modeling, analysis, and enactment of business processes. Typically, a management system in a large corporation refers to a central or centrally coordinated system of computer expertise and management, often including mainframe systems but also including by extension the corporation's entire network of computer resources. The term is used broadly in a number of contexts and includes but is not limited to: knowledge management systems, decision support systems, resource and people management applications, project management, document management, workflow management and database retrieval applications. Typically management systems obtain information from and provide information to individual employees operating at all levels of a business enterprise from executives dealing with strategic decision making down to low-level employees constituting multi-member workgroups that are established for the performance of specific projects. In computer-based management systems the functional information is stored in specific data structures referred to as management information files that are kept in the memory banks of one or more computing devices. A plurality of input data is inserted to and a great variety of output data is extracted dynamically from the management information files. Every employee who in the framework of his responsibilities has to interface with the computing devices operative within the organization is collaborating (knowingly or unknowingly) in the creation, update, and processing of these files. A substantial number of top-level employees, such as executives utilize the data within the files in order to access and interact with the methodically organized information therein that is needed for strategic-level or tactical-level managerial decisions. Currently, a plurality of computer-based management systems are offered for sale to enterprise-level users in order to provide assistance in the running of the business. Most of the systems sold currently have a number of significant drawbacks. The main problem of the systems supplied today is in regard to their basic design philosophy. Most present management systems attempt to provide a comprehensive solution for computerized management and therefore endeavor to cover the whole range of organization activities. The current systems attempt to obtain and process data from practically all the business-related computing applications within an enterprise such as accounting, manufacturing, inventory, bill-of-materials, customer orders, marketing, budget, customer relations, payroll, accounts payable, accounts receivable, e-mail, messaging, and the like, in order to record the data within management information files. The information files are formed such as to be used as the basis for decisions by the top management of an organization. Unfortunately the complexity of the information obtained from the regular application sub-systems, which are often non-standard, legacy systems, based on complex data structures, create correspondingly complicated information files. Typically the size of the resulting information files is exceedingly large effecting long running times. Furthermore, the complexity and diversity of the information within the resulting information files necessitates the utilization of a plurality of diverse output procedures. Although some information files are built independently of the existing sub-systems these original files also have to confirm to the general configuration of the existing system. Therefore the original procedures developed particularly to handle management files are also cumbersome. As a result of this complexity and diversity of data structures the currently operating computer-based management systems are all too often substantially complicated, acutely slow, exceedingly difficult to master, and nearly impossible to implement in an efficient manner. Studies of human behavior clearly show that members of a workforce such as employees in a business organization will perform predefined operating procedures associated with business-related tasks provided that certain operating conditions are satisfied. Without fulfilling these conditions the predefined procedures will not or can not be executed. The most important condition regards the attribute of “workability” or “feasibility”. A procedure is workable or feasible when a reasonably competent individual is able to master it, to assimilate it, and perform it during a reasonable length of time. Thus a feasible procedure is readily performed while an unfeasible procedure is difficult or even impossible to understand, to master, to assimilate, and to implement. It can be safely assumed that tasks too complicated to understand, too difficult to learn, which require an unreasonably long period to assimilate, and too complex to perform will not be fulfilled even by a highly motivated workforce such as executive managers operating within an ordered and well-organized environment such as a business enterprise. Individual employees comprising the workforce of a business enterprise expect that the top-level executives operating within the management level provide the organization with leadership. Managers are also expected to have executive characteristics that will make the organization efficient, competitive, and profitable. The employees expect the guidance, the assistance, and instruction of the management in performing assigned functions within the business environment. In order to enable the employees to perform their assigned functions it is routinely expected that the management provide the best available tools, which will allow the workforce to perform their assigned functions in the best possible manner. If a management system is operative within the enterprise it is expected that the system provided will be the best available within realistic financial constraints or at least will have the attribute of “feasibility” such that functions assigned to employees regarding the operation of the system could be performed. A great number of management systems are offered today by diverse bodies such as software vendors, industrial groups, international standard organizations, and the like. The best-known available management systems, each with its respective advantages and disadvantages, will be described next. ISO 9000 is a family of standards approved by the International Standards Organization that define a quality assurance program. Companies that conform to these standards can receive ISO 9000 certification. This doesn't necessarily mean that the company's products have a high quality; only that the company follows well-defined procedures for ensuring quality products. The standard focuses on the constant improvement of the quality of work within an enterprise via specifically defined procedures and specific control methods. The standard includes excellent definitions but does not provide the suitable tools for the implementation of the ideas detailed therein. Therefore each organization following the standard has to develop independently its own practical tools. TQM (Total Quality Management) is both a philosophy and a set of guiding principles that represent the basis of the continuously improving organization. TQM is the application of quantitative methods and human resources to improve the material and the supplies to an organization, all the processes within an organization, and the degree to which the needs of the customer are met, now and in the future. TQM integrates fundamental management techniques, and existing improvement efforts under a disciplined approach focused on continuous improvement. TQM is an excellent guiding method. The drawback of TQM is identical to the disadvantage of the ISO 9000; namely it does not provide practical tools for the implementation of its defined principles. Knowledge management is the name of a concept in which an enterprise consciously and comprehensively gathers, organizes, shares, and analyzes its knowledge in terms of resources, documents, and people skills. In early 1998, it was believed that few enterprises actually had a comprehensive knowledge management practice in operation. Advances in technology and the way information is accessed and shared have changed that; many enterprises now have some kind of knowledge management framework in place. Knowledge management involves data mining and some method of operation to transmit information to users. The method describes in detail why knowledge should be documented but does not explain the practical details. In addition no simple, inexpensive and practical tools are provided. Enterprise resource planning (ERP) is an industry term for the broad set of activities supported by multi-module application software that. helps a manufacturer or other business manage the important parts of its business, including product planning, parts purchasing, maintaining inventories, interacting with suppliers, providing customer service, and tracking orders. ERP can also include marketing, distribution, development, and application modules for the finance and human resources aspects of a business. Typically, an ERP system uses or is integrated with a relational database system. The deployment of an ERP system can involve considerable business process analysis, employee retraining, and new work procedures. Therefore implementing ERP in an organization is extremely difficult and the process of tailoring the software to the specific needs of the enterprise may take several years even with the help of a dedicated implementation team. Just In time (JIT) is a management method developed in Japan which focuses on the timing of resources (raw materials, finished parts, and components supplied by external contractors) that is received by a manufacturing business enterprise. The central idea is to receive each item only at that point in time when it is needed in order to save handling time and financing. Like the above mentioned other methods JIT also an excellent system. The drawback of JIT lies in the fact that it relates only to specific parts of the managerial activity scope in an organization. Other management techniques such as strategic planning, operational research, brain storming, management by objectives, and the like, contribute valuable methods and techniques to specific managerial fields in an organization. Thus, all these techniques relate and handle only specific segments of the enterprise activity complex. From the foregoing it is obvious that the computer-based management systems available today have two principal non-related drawbacks. Some systems are little more than well-developed theories of management or well-defined abstractions such as definitions regarding essential management procedures without the provision of practical tools operative in the application of these procedures. Other available management systems do provide comprehensive application software tools but typically the proposed tools are extremely difficult to master, to assimilate, and to implement in a realistically configured commercial, manufacturing, or financial environment such as a business enterprise. Typically executives managing a business enterprise are primarily occupied with routine tasks related to the daily running of the organization. Therefore their heavy responsibilities leave them with no spare time for experiments in the application of abstract theories of management inherent within some of the proposed management methods to the operation of their organizations. The executives pursuing their management tasks are also unable to master comprehensive, complex, non-user-friendly software that is typically associated with the currently offered management system packages. Therefore, currently available computer-based management systems can not provide sufficiently practical solutions for the problems encountered by managers running a business within a realistic environment. It would be easily perceived by one with ordinary skill in the art that a clear and present need exists for a practical management system and method, which provides a set of user-friendly, simple, logical tools that systematically cover the entire field of business enterprise management. Such a system and method should provide the required “feasibility condition” in order to enable the executives and all the employees at all levels of a business environment to perform their management system-related functions readily, efficiently, and effectively.

### SUMMARY OF THE PRESENT INVENTION

One aspect of the present invention regards a computer-based organization management method for the establishment, systematic and creative building, integration, distribution, sharing, and controlling of information operative in the management of an organization. The method includes the steps of generating at least one document template on the computer readable media for the storage of the at least one organized and formatted organization information unit concerning the structure and functionality of the organization, and creating at least one procedure document based on the at least one organized and formatted organization information unit stored in the at least one document template established on the computer-readable media.

A second aspect of the present invention regards a computing environment that includes a computing platform having a central processing unit, an input device, a display device, and a memory device, and a computer-based organization management system. The management system consists of a management knowledge base containing management knowledge files and a management system containing a set of organization management modules executable by a computer. The management knowledge files include at least one knowledge document file for storing a series of tasks to which at least one user of the system is charged with, at least one knowledge document definition file for defining the format of the at least one knowledge document file, a content formatter module to provide structuring and formatting to at least one organization content definition file. The management system includes a procedure formatter to provide structuring and formatting to the at least one procedure file, a reminder formatter to provide structuring and formatting to the at least one reminder, a reminder handler to handle reminders, a table builder to provide generic creation of tables, a form builder to provide generic form building, a text editor to provide for specialized text processing, and a check list builder to provide for check list document creation.

A third aspect of the present invention regards a computing and communicating environment accommodating at least one client system connectable to a server system and a computer-based organization management method for establishing, distributing, studying, sharing, maintaining and supervising document-based information functional to the management of an organization. The management method includes generating at least one content format document on the computer readable media for the storage of the at least one structured and formatted organization information unit concerning the activities of the organization, and building at least one procedure document based on the at least one structured and formatted organization information unit stored in the at least one content format document established on the computer-readable media.

The present invention provides for a set of management tools covering the entire range of management activities associated with organization management at all executive levels.

The present invention provides the executives operating on the various management levels practical executive methods for ready management and control of the organization.

The present invention provides executives to master systematically practical management methods in order to acquire practical skills.

The present invention provides for the collection, accumulation, documentation, and storage of all the available organization-related knowledge.

The present invention provides the building of methodical procedures for the constant improvement of the working processes within the organization.

The present invention provides for substantial simplicity in the performance of the method.

The present invention provides for the rapid distribution of the accumulated organization knowledge, for the recording and controlling of a set of tasks allocated in the organization.

The present invention provides for a comprehensive, systematic, well defined, practical, readily implemented, and easy to learn organization management solution in realistic environments.

### BRIEF DESCRIPTION OF THE DRAWINGS

The present invention will be understood and appreciated more fully from the following detailed description taken in conjunction with the drawings in which:

FIG. 1 is an exemplary environment within which the proposed system and method is operative, in accordance with the preferred embodiment of the present invention; and

FIG. 2 illustrates in more detail the components involved in the operation of the proposed method and system, in accordance with a preferred embodiment of the present invention; and

FIG. 3 is a simplified block diagram that illustrates the structure of an exemplary content format, in accordance with a preferred embodiment of the present invention; and

FIG. 4 depicts the procedure format, in accordance with a preferred embodiment of the present invention; and

FIG. 5 describes the logical flow associated with the creation of a standard procedure record, in accordance with a preferred embodiment of the present invention; and

FIG. 6 depicts a data structure representing the task table, in accordance with a preferred embodiment of the present invention.

### DETAILED DESCRIPTION OF THE PREFERRED EMBODIMENT

### Definition of Specific Terms Used

Performance Feasibility conditions: Action or process-related conditions, which when fulfilled enable a reasonably competent individual to perform the action or the process. Without fulfilling these conditions a reasonably competent individual will not be able to perform the action or the process.

Organization: A group of individuals co-operating to accomplish specific commonly desired objectives. The group is typically led by a group manager. A sub-organization within an organization is also defined as an organization.

Project: A specific sub-group of an organization, which typically includes individuals internal to the organization, and others external to the organization. The sub-group is formed temporarily in order to develop products/services/processes. Objectives and target dates are parts in the definition of the project. Typically after the completion of a project the group of individuals associated therewith is disbanded.

The objective of the present invention is to provide a set of computer-based, practical, user-friendly management tools, which substantially cover the entire range of management activities associated with enterprise administration at all the executive levels from top-level senior executive managers to low-level team leaders. The users of the tools are the various executives operating on diverse management levels within the organization. By utilizing the proposed tools the owners of the organization will accomplish the following objectives:

a) avoidance of absolute dependence on the knowledge accumulated in the hands of specific executives or other members in the organization

b) preservation of documentation of the knowledge within the organization

c) increasing of the profitability of the business enterprise

d) increasing of the survivability of the organization.

The tools provide the diverse executives operating on various management levels practical executive methods, which extend across the entire range of managerial duties assigned to managers responsible for the proper operation of a particular organization. By utilizing the tools the executive users will accomplish the following managerial objectives:

a) comprehensive understanding of the objectives, structure, and operations of the organization

b) ready management and control of the organization

c) ready access to each and every working process in the organization

d) simple knowledge documentation procedures

e) ready understanding and documentation to components of working processes

f) concentration of the entire set of knowledge types associated with a specific subject in a single record to provide collaborative usage of the data in the record to users at the different levels and to prevent duplicity and missing updates

g) rapid and ready updating of the data in the records storing the accumulated knowledge

h) distribution of the accumulated knowledge and verification of the data by the users at the different levels

i) recording and controlling the entire set of tasks allocated in all the levels of the organization

j) user-friendly interfaces, rapid execution (seconds) and product documentation for instructing users, which provide a steep learning curve.

The tools further provide junior executives with the option to master systematically practical management methods extending across the entire range of managerial responsibilities the prospective manager will have to carry out in the course of his office. The junior executive practices his studies in order to accomplish the following objectives:

a) acquiring practical managerial skills as a preparation for the commencement of his work within the organization

b) improving his already acquired managerial skills in accordance with the predefined functions to be fulfilled within the organization.

The collection of management tools cover the practically the entire range of activities a manager has to perform within an organization such as:

a) analyzing the structure, the objectives, and the operation of the enterprise

b) creative development of useful working procedures and effective supervisory and control methods

c) planning and developing orderly work processes

d) developing effective supervision procedures

e) collaboratively distributing enterprise-related knowledge

f) dynamically sharing enterprise-related information

g) allocating tasks associated with accomplishing the objectives of the enterprise

h) effectively supervising the performance of the allocated tasks

i) recruiting, organizing and directing a workforce.

The proposed system and method enables the collection, accumulation, documentation and storage of all the available enterprise-related knowledge. The set of management tools provided is designed to assist in the creation of methodical procedures for the constant improvement of working processes within the enterprise. The method is practiced via well-defined techniques, which transform the intuitive practice of “management as art” into an ordered collection of elementary step-by-step procedures that can be mastered systematically.

The proposed system and method is based on the assumption that a common, popular, and sophisticated word processing software product with a substantially high market-penetration such that it is used by millions of individuals throughout the world is known to practically every individual employee in the workforce of an enterprise. Alternatively, the information needed to instruct individual employees in the suitable manipulation of a word processing software product, which is used in an organization, is typically an enterprise-owned knowledge. Therefore, teaching and learning how to operate such a word processor software is comparatively straightforward and it is assumed that practically every individual employee functioning within the enterprise can readily master its basic operating procedures in a relatively short time. Obviously such a work processing system is “feasible” in that sense in which it was defined in the foregoing. Therefore, by utilizing a known word processing software product the principal management information system interface will provide the proposed management system and method disclosed in the preferred embodiment of the present invention with the required “feasibility” attribute.

In the preferred embodiment of the present invention the word processing application employed is “Word” that is a widely known and widely used application developed and distributed by the Microsoft Corporation. It would be easily understood that in other preferred embodiments of the present invention other known word-processing program products could be employed as the document processing interface for the proposed method and system. In yet other embodiments of the present invention a specifically developed program product with suitable word processing capabilities could be implemented as the document processing interface.

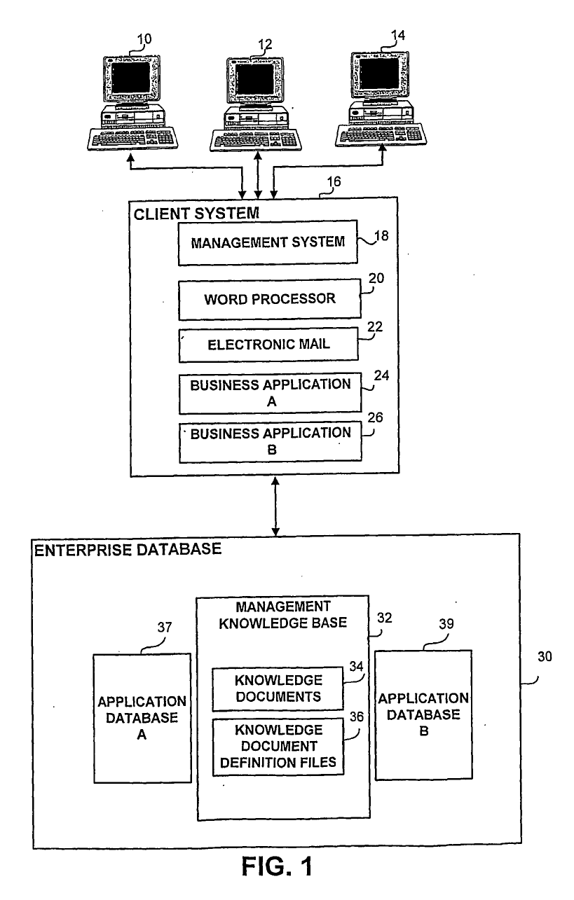

Referring now to FIG. 1, that illustrates an exemplary environment within which the proposed system and method is operative, in accordance with the preferred embodiment of the present invention. Computing devices 10, 12, 14 are utilized by the potential users of the proposed system and method. The users could be individual members in a business enterprise's workforce such as managers, project leaders, and other personnel. In the preferred embodiment of the present invention devices 10, 12, 14 are non-centralized computing platforms with client systems software 16 implemented therein. Devices 10, 12, 14 are communicatively or permanently and continuously connected to one or more suitable enterprise server systems (not shown) implemented on one or more computing platforms (not shown). Devices 10, 12, 14 enable the users thereof to access and to interact with the enterprise server-based computer applications and with the associated enterprise database. In other preferred embodiments of the present invention devices 10, 12, 14 could be non-intelligent interactive display terminals linked permanently to one or more mainframe computer platforms (not shown). It would be easily understood that although on the discussed drawing only a limited number of computing devices are shown in a realistic computing environment a plurality of computing devices could be utilized. In contrast, in other preferred embodiments only a single computing platform, such as a personal computer (PC), would be employed where all the functional hardware and software components and associated data structures would be implemented on the same single computing platform. Yet in other preferred embodiments the above-mentioned PC could be a node within a data communication network, such as a local area network (LAN), a wireless local area network (WLAN), a wide are network (WAN), or the like.

In the preferred embodiment of the present invention client system 16 consists of diverse application programs that provide the functionality for the operation of the typical software systems in a typical business enterprise environment. The applications could consist of software sub-systems operative in diverse business-related diverse domains such as manufacturing, warehousing, customer relations, billing, budgeting, accounting, and the like. In other embodiments of the present invention the collection of software programs constituting the specific application software could be installed on and operated from one or more centrally located mainframe systems. In additional embodiments of the present invention all or some of the applications could reside on one or more centrally located enterprise server systems. Yet in other embodiments of the present invention all or some of the applications could be implemented on a standalone personal computer (PC) or on a set of PCs operating in the framework of a data communications network, such as a Local Area Network (LAN), a wireless local area network (WLAN), a wide area network (WAN), or the like.

In the exemplary environment, currently discussed in association with the present drawing, client system 16 contains a management system 18, a word processor 20, an electronic mail application 22, and additional business applications 24, and 26. Thus, client system 16 includes a set of computer programs specifically designed and implemented for providing the proper operation of the proposed system and method. Client system 16 further includes software application systems closely related to the operation of the proposed system and method, such as the word processor application 20, and the e-mail application 22. In the preferred embodiment of the present invention the management system 18 periodically activates, utilizes, and controls specific functions of the word processor application 20 and of the electronic mail application 22. Management system 18 may include additional modules such as employee qualifications tracing module, employee teaching module, employee authorization module, and knowledge document changes tracing module. It would be easily understood that the word processor application 20, electronic mail application 22, as well as the additional applications 24, 26 have the capability of operating independently of the management system 18 for the purposes that were originally designed and developed. In would be further understood that additional applications supporting the proposed method and system could be added in order to provide supplementary capabilities to the management system. Client system 16 is linked to enterprise database 30. Enterprise database 30 is a set of data structures containing information functional to the operation of the business enterprise. In the preferred embodiment of the present invention database 30 is held on one or more storage devices (such as hard disks) of one or more enterprise servers. In other embodiments of the present invention database 30 could be stored on one or more storage devices (such as hard disks) of one or more centrally located mainframe computers. Yet in other preferred embodiments database 30 could be stored as a set of files distributed across the suitable storage devices of the client systems 10, 12, and 14. In further embodiments of the invention database 30 could be stored on a memory device of personal computer (PC), where the PC could be a standalone computing device or could be a specific particle of a data communications network, such as a LAN, a WLAN, a WAN, or the like. Enterprise database 30 contains a management knowledge base 32 and other application-specific databases 37, 39. Knowledge base 32 is a set of data structures such as computer files functional to the operation of the management system 18. The management system 18 is operatively linked to the data structures constituting enterprise database 30. Knowledge base 32 holds the information essential to the operation of management system 18. Knowledge base 32 includes knowledge documents 34, and the knowledge document definition files 36. Knowledge documents 34 are files having specific format, structure, and other properties. The format, the structure, and the other properties of the knowledge documents 30 are predefined via the information maintained in the knowledge document definition files 36. Metadata is a definition or description of data. Knowledge documents 30 are data objects that are specific instances of predefined metadata objects stored in the knowledge document definition files 36. Documents 34 are created and maintained specifically by the users of devices 10, 12, 14 in order to define, to describe, and to control specific procedures, tasks, and processes essential for the accomplishment of the objectives of the business enterprise. Documents 34 are also utilized as follow-up tools to enable users to follow the performance of the defined tasks. Data object instances included within the document files 34 contain all the information needed for a set of individuals involved in the controlled execution of a specific task. Document files 34 also include procedures that provide the users of the system with tools for systematic and creative targeting of objectives. Knowledge document definition files 36 are the metadata structures utilized as predefined templates to specific data object instance documents. Definition files 36 are created by the appropriately authorized individuals such as managers or project leaders within the organization through the activation of management system 18 via devices 10, 12, and 14.

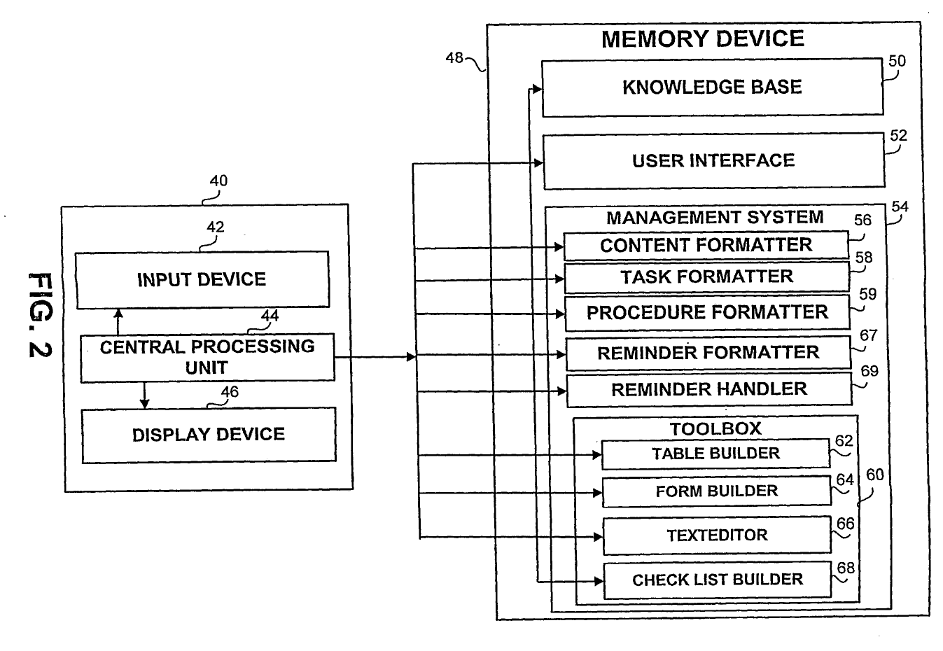

Referring now to FIG. 2 that illustrates in more detail the components involved in the operation of the proposed method and system in accordance with a preferred embodiment of the present invention. Device 40 is a computing platform operated interactively by a user such as an individual employee of a business organization in order to access and interact with the software routines the metadata and the data object instances associated with the proposed system and method of the present invention. Device 40 can be a stand-alone computing device such as an independently operating personal computer PC, a computing device that is connected to and operating within a computing and communications environment such as a local area network (LAN), wide area network (WAN), or a wireless local area network (WLAN), or any combination thereof. When operating in as a network particle device 40 could be linked to the network via hardwired cables, radio links, infrared links, satellite links, or the like.

Device 40 contains an input device 42, a central processing unit (CPU) 44, a display device 46, and a memory device 48. The input device 42 is operative in providing the user with the option of selecting a specific action to be taken and communicating the desired action to the software routines controlling the operation of the system. Input device 42 could be a keyboard device, a pointing device such as a mouse, a touch screen, or the like. CPU 44 is a processor device or a microprocessor device that contains the logic circuitry designed for the performance of the software instructions embedded within the computer programs constituting software applications. Display device 46 is a computer output surface and projecting mechanism that provides visual interaction between the user and the system by presenting suitable predefined text and optionally graphical structures to the user of the device 40. The display typically includes answers to queries or feedback to the input data initiated by the user. Device 46 is typically uses a cathode ray tube (CRT), a liquid crystal display (LCD), a plasma screen, or any other image projection technology. Memory device 48 is a storage device such as a hard disk. Device 48 holds the software files, which constitute the computer's operating system, the utility sub-systems, and the user application systems. Device 48 also stores the data structures including various information tables associated with the various software systems. In the preferred embodiment of the present invention device 48 stores a knowledge base 50, a user interface routine 52, and a management system 54. Management system 54 contains a content formatter routine 56, a task formatter routine 58, a procedure formatter routine 59, a reminder formatter 67, a reminder handler 69, and a toolbox routine 60. Toolbox routine 60 includes but not limited to a table builder routine 62, a form builder routine 64, a text editor routine 66, and a check list builder routine 68. Toolbox routine 60 could include a plurality of additional tools, such as an application builder, and the like. User interface 52 comprises a set of programs operative in providing the individual user with appropriate interactive processes to the system. Interface 52 includes displayable graphical structures such as windows, buttons, menus and the like, which provide the individual user with the capability of activating the various software components in order to manipulate the diverse data object instances such as document files associated with the functions of the management system. Management system 54 is a set of software routines constituting the management system application. Content formatter routine 56 provides the means to input the information obtained by analyzing and mapping the organization. The information inputted to content formatter routine 56 is structured and stored into specific metadata files to provide clear understanding of the enterprise and readily controlling the operation of the organization. A detailed description of the content format will be set forth hereunder in association with the following drawings. Procedure formatter routine 59 is a set of software routines, which defines the entire set of working procedures within the enterprise. The procedures span the entire range of the activities associated with the organization and provides for simple and ready documentation of all the necessary knowledge associated with a given working procedure. The procedure format includes a predefined number of layers where each layer is intended for the use of a distinct user. A detailed description of the procedure format will be set forth hereunder in association with the following drawings. Task formatter routine 58 is operative in building task formats that enable registration of the entire range of tasks and decisions needed for the accomplishment of the objectives of the organization. The task formats also provide the means for controlling the performance of the tasks and closely observing the decision making process. A detailed description of the task format will be set forth hereunder in association with the following drawings. Toolbox routine 60 comprises a set of software utilities designed to enable the elaboration of established working methods and particular projects. Toolbox routine 60 provides the methods to enable simple and ready documentation of the working processes. Toolbox 60 provides a set of useful functions to the individual users such as creating tables (62), building specific forms (64), defining multi-usage text strings (66), and creating checklists (68). Toolbox routine 60 can include a plurality of additional tools, such as application builder routines and the like.

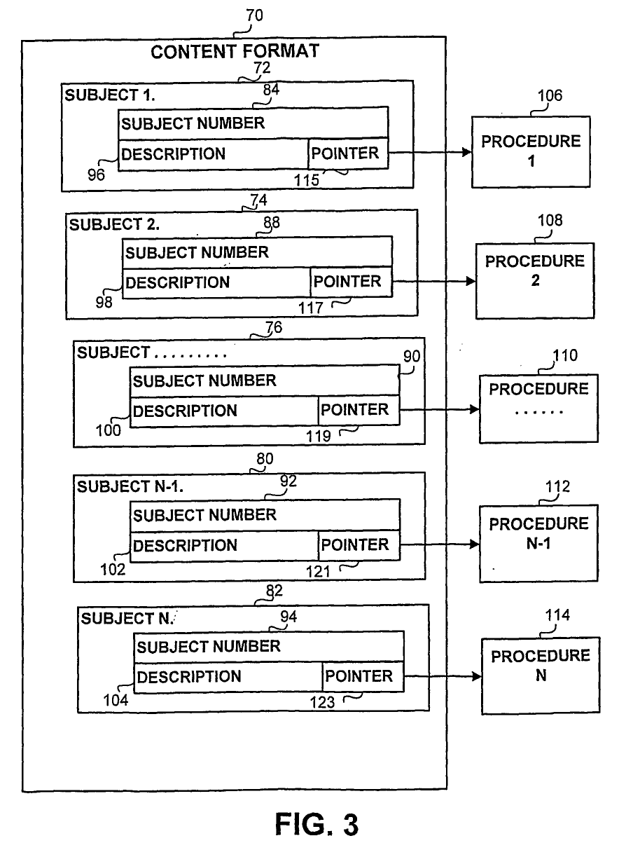

FIG. 3 is a simplified block diagram that illustrates the structure of an exemplary content format created by the content formatter routine 56 of FIG. 2. Content format 70 is a data structure stored within the knowledge document definition files 36 of FIG. 1. Content format 70 includes data records that comprise a collection of data items arranged for processing by a computer program where each record represents a specific subject associated with a functional field in the operation of an organization. In the preferred embodiment of the present invention content format 70 contains subject 72, subject 74, subject 76, subject 80, and subject 82. A subject record includes but is not limited to a subject number field, a subject description field and an address field to point to a subject-specific procedure description record. Thus, subject record 72 contains subject number field 84, subject description field 96, and procedure address field 115. Procedure address field 115 points to procedure description record 106. The function of record 106 is to describe all the operative procedures associated with subject 72 in minute detail. Similarly subject record 74 contains subject number field 88, subject description field 98, and procedure description record address field 117. Procedure record address 117 points to procedure record 108, which describes the necessary procedures associated with subject 74 in minute detail. Subject record 76 contains subject number 90, description 100, and procedure record address 119, which points to procedure record 110. Procedure record 110 accordingly describes the operative steps of the procedure associated with subject 76 in detail. Subject record 80 includes subject number 92, description 102, and procedure description record 112 address value 121. Subject record 82 contains subject number 94, description .104, and pointer 123, which links subject record 82 to associated procedure description record 114. In addition in other preferred embodiments different structures could be used. For example, subjects could be collected into specific subject clusters or subject groups. For each cluster additional information could be defined such as periodic control dates, record administrator identification, control team identification and the like. The subjects can be organized in predefined clusters representing the learning progress of an employee within the enterprise. A specific cluster could include basic information while other clusters could provide more advanced knowledge. The content format 70 is created in order to provide an abstract model of the organization. The organization and its constituent parts, such as divisions, sub-divisions, departments, and the like, are analyzed in depth in order to obtain comprehensive data concerning their structure, activities and functionalities. The collected information will be organized to reflect the detailed structure and required functionality of the organization. Then, the organized data is suitably mapped into the content format files in order to allow a full understanding of the organization, and to enable ready control and management. In the preferred embodiment of the present invention, the word processing application employed is able to handle hypertext links. Therefore in the embodiment the pointer values linking the different records are replaced by suitable hypertext links. In other preferred embodiments diverse other integral built-in linking methods could be used. The detailed techniques used to create the records representing the different formats and documents of the proposed system and method will be provided hereinafter in association with the following drawings.

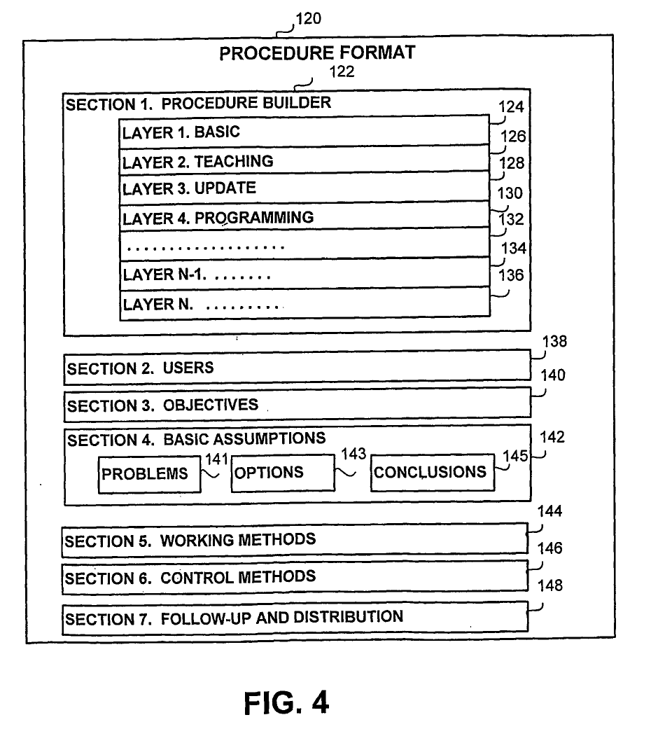

Referring now to FIG. 4 that depicts the procedure format created by the procedure formatter routine 59 of FIG. 2. Procedure format 120 is a data structure held in the knowledge document definition files 36 within the management knowledge base 32 of FIG. 1 where a plurality of procedure formats is defined. A format is a metadata object that can be used as a template for a text file describing one or more working procedures that have to be performed in the organization. Thus, a procedure format object includes all the information needed for the building of a procedure record. The exemplary procedure format object 120 illustrated on the presently discussed drawing is a set of procedure records. The records are divided into discrete sections and separate layers placed within each of the defined sections. In the preferred embodiment of the present invention procedure format object 120 includes seven predefined section records 122, 138, 140, 142, 144, 146, 148 with each section record holding a specific class of information. Thus, in the preferred embodiment section record 1 (124) contains the procedure building routine.

The section record 2 (138) includes the designated users of the procedure. A user of the procedure is defined as a group, a team, an individual, or a process that effects the procedure in some manner and is effected by the procedure. The section record 3 (140) comprises the definitions of the direction and objectives of the procedure. The section record 4 (142) indicates basic assumptions and includes known problems 141, problem-related or objectives-related associated options 143, and resulting conclusions 145. The section record 5 (144) describes the working methods such as processes, tasks, functions, and equipment. The section record 6 (146) defines control methods, and section record 7 (148) depicts the changes and evolution of the procedure and defines knowledge distribution lists for the appropriate knowledge workers. and for the respective users. The layer records defined within each section record are designated for specific users. Layer record 1 (124) is the basic layer intended for the user effected by or effecting the procedure in a specific manner. Layer record 2 (126) is the teaching layer intended for the instructor. Layer record 2 can be utilized for self-study by the learner. The layer record 3 (128) is utilized by the builder of the procedure, and layer record 4 (130) is intended for the programmers of the procedure. Logically there is no limitation to the number of layer records that could be defined within each section record. Therefore other layer records (134, 136) can be defined and utilized when needed for various other purposes, which can be associated with a specific working procedure. A working procedure record 106, 108, 110, 112, 114 of FIG. 3 is built by utilizing the appropriate procedure format metadata structure 120 of FIG. 4. Typically the procedure format object 120 is used as a template to the procedure record. The procedure record is typically created by an individual user of the proposed system and method having the responsibility for the completion of the working procedure. The entire set of diverse and useful processes associated with a working procedure such as teaching functions, performance, control, and follow-up are executed only according to the information inserted into the body of the specific procedure record by the particularly authorized user. A procedure record can be displayed, printed, or the like, in entirety or partially where certain defined sections or certain defined layers within the selected defined sessions can be selected for display or for print.

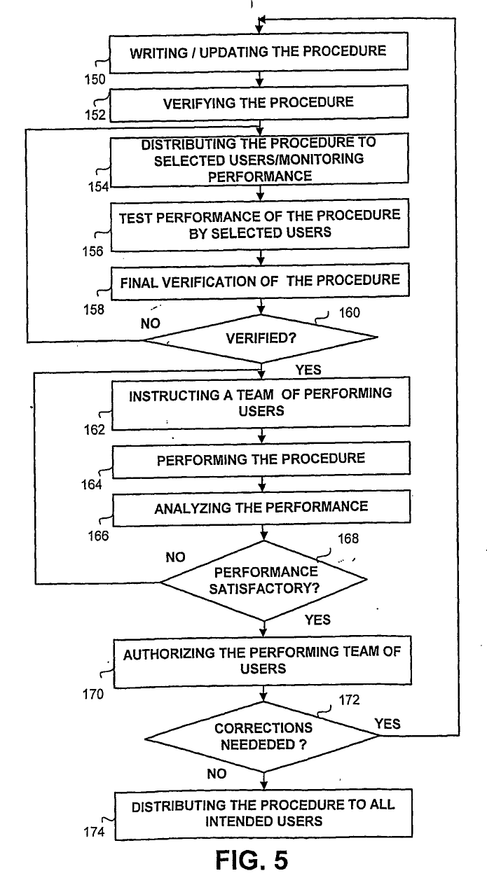

In order to test the practicality of a theoretical procedure the newly-created procedure record has to be verified, checked, modified, re-checked and confirmed in field conditions. FIG. 5 describes the logical flow associated with the creation of a standard procedure record 120 of FIG. 4. The flow chart illustrated on the discussed drawing also describes the dynamic manner in which the procedure is maintained, controlled, tested, and optionally modified. A new working procedure has to be defined typically following the identification of a new problem or need within the organization. The identified problem is typically resolved by the implementation of a new working procedure. In order to implement a new working procedure a new procedure record 106, 108, 110, 112, 114 of FIG. 3 have to be created as a data file within the knowledge document files 34 of FIG. 1. A suitable employee is authorized to write the procedure. At step 150 the procedure text is prepared and inserted into the knowledge base as a procedure record. At step 152 an authorized user checks and verifies the text of the procedure record. At step 154 the procedure is distributed to one or more selected performing users and the performance of the procedure is monitored. At step 156 the procedure is performed and at step 158 the final verification is executed. At step 160 it is determined whether the procedure is verified. If the procedure is not verified then program control returns to step 164 for further monitoring of the procedure performance. In contrast, if at step 160 the procedure is verified then at step 162 a team of performing users is instructed with respect to the procedure. Next at step 164 the team performs the procedure and at step 166 the performance is suitably analyzed. At step 168 it is determined whether the performance of the team was satisfactory. If the result is negative then program control returns to step 162 to allow for further instruction of the performing team. If the performance is satisfactory then at step 170 the performing team is authorized with respect to the performance of the procedure. Next at step 172 it is determined whether the procedure needs corrections. If the result is negative then program control returns to step 150 for the updating of the procedure. If no corrections are needed then the procedure is distributed to all the intended users.

In other preferred embodiments of the present invention, a newly-created procedure record 106, 108, 110, 112, 114 of FIG. 3 could be linked optionally to a group of procedures defined within the content format, and/or to a group of employees having specific capabilities, and/or a list of teaching sessions/instructors, and/or to control schedules of comptrollers/authorizers. Optionally the management system can produce and deliver various reminders to potential users of the document. A reminder is a structured note that can be produced and sent to an individual employee concerning teaching, self-study, performance, and acquiring authorization for the performance of a specific task or a procedure, to an instructor concerning the teaching of an individual employee, to a manager concerning the authorization of an employee, to a controller, and the like. The system provides to the entire group of users with the capability of reporting about the progress made during the execution of the procedure, and provides to authorized members of the group such as controllers with the capability of following the progress of the trained employees.

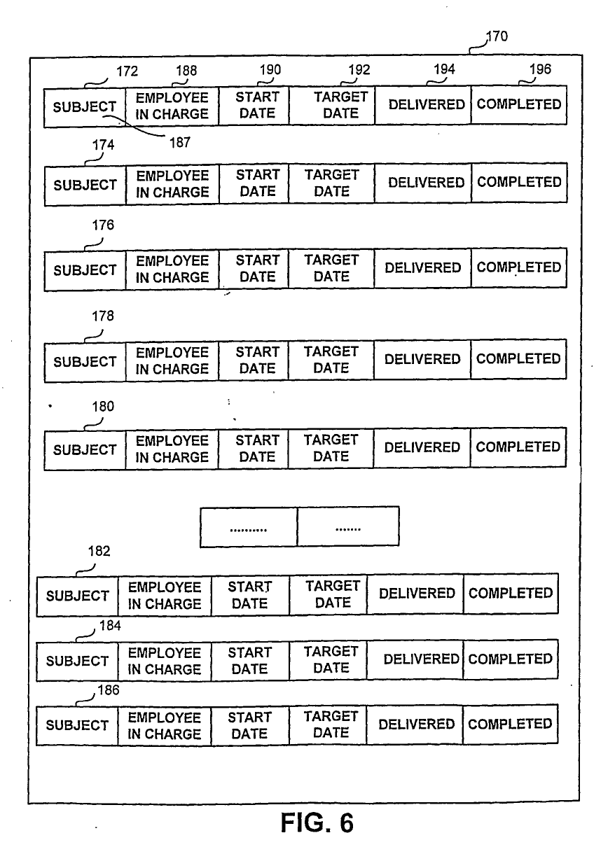

Referring now to FIG. 6 which depicts the data structure representing the task table. The task table is a collection of task records defined and created by a specific working team that can be in association with a standard working procedure or a specifically defined project or every other working team. A task record is built by a member of the working team that is typically an individual authorized to assign tasks to the working group. Tasks can be assigned by a manager, by the entire planning team, by the project team leader, or by any other authorized employee. The individual assigned to the performance of the task can be an employee having certain skills and capabilities to perform particular task-related functions, or can be one or more member of a team. Task records can be assigned to a function associated with the task, such as “electrical engineer”, or to a job group associated with the task, such as “network controller design”, or to a group, such as “application interface developers”. Task records are created by the activation of the task formatter routine 58 of FIG. 2. During a planning meeting associated with a project a set of decisions is taken by the participating planning team and consequently a set of task records is built. Task records collected into task tables are routinely created for every work team or project team functioning in the organization. Utilizing the implemented management system software the created task records are sent to the reminder formatter 67 of FIG. 2. The reminder formatter 67 of FIG. 2 suitably processes the task records, extracts the relevant information therein and forwards the resulting reminder records to the reminder handler. 69. Reminder handler 69 transmits the reminder records to the individuals responsible for the completion of the tasks. In the preferred embodiment of the present invention, the reminder handler routine used can be the Outlook software product developed and distributed by the Microsoft Corporation. In other embodiment of the invention other products could be used, such as the Palm computing platform developed the Palm Computing Inc., or the like. Outlook is a sophisticated electronic mail system that supports the timely delivery of reminder notes typically via traditional electronic mail connections by using known communication protocols. The reminder notes are sent in text format where the activation of the notes is based on specifically formatted text documents, which store the suitable e-mail addresses of the recipient and predefined date fields operative in the activation of the delivery of the note. It should be understood that in other preferred embodiments of the present invention, the delivery of the reminder notes can be performed in a different manner such as by using diverse other electronic mail systems employ specifically developed processing and delivery routines. The reminder notes could be delivered via various data communications networks, such as the Internet. Still referring to FIG. 6 task table 170 contains task records 172, 174, 176, 178, 180, 182, 184, 186. The task records include identical data fields. Thus, the data fields constituting task record 172 are but not limited to a task subject 187, an employee in charge of the task 188, a starting date 190, a target date 192, a delivery indication flag 194, and a completion indicator flag 196. Although the data fields associated with the other tasks 174, 176, 178, 180, 182, 184, 186 are not denoted by suitable numbers it will be clear that all the tasks in the task table 170 have an identical structure. The task subject field 187 contains a description of the task in text format such as “Preparing drawings and examples”. The employee in charge of the task field 188 is set to a name or a function such as “project leader”. The starting date field 190 is set to date on which the task was initiated or should be started, and the target field 192 value is either set to a predefined target date or left open in order to enable the task formatter to compute the suitable date. The flag values 194 and 196 are set to indicate various status changes related to the task. Field 194 indicates that the task was delivered to the suitable individual and field 196 indicates the completion of the task. The proposed method and system provides for sending each suitable individual in the organization a set of documents describing the tasks thereof. The received documents are sent from the entire set of task tables created and controlled by the entire set of working teams or project teams. Therefore, each appropriate individual employee will receive from the remainder module one or more pages relating to tasks in the organization describing his or her task assignations from all the personal assigning tasks in the organization. In addition the suitable employee will receive periodic reminders in regard to dates critical to the progress of the assigned task. It will be easily comprehended that the structure and functionality of task records described hereinabove are exemplary only and in other preferred embodiments of the present invention a number of alterations and modifications could be made. Supplementary useful data fields can be added to the present structure such as task duration, task priority, task control methods, dates for periodic reminders, and the like. Some of the existing fields could be also removed without substantially altering the operation of the proposed system and method. The proposed method and system is based on the utilization of shared and structured data objects in a specific software file format. The data objects are having encoded content that represents text documents. The common structure of the shared data objects is based on predefined and specifically structured metadata objects. The metadata objects represent the underlying document structure. Both the metadata objects and the shared functional documents are deployed in one or more common document repositories on one or more memory devices of one or more computer devices. The documents are created, updated, distributed, manipulated, displayed, and controlled via the services of a specifically designed set of commonly-used computer programs installed in one or more computing devices. Individual employees operating collaboratively on various levels of a business organization manipulate the documents in order to accomplish the common objectives of the organization. The shared documents describe processes necessary to the accomplishment of the objectives of the organization. The shared documents are divided into procedures, and task definitions. The documents are created by utilizing the predefined underlying metadata structures. The metadata structures are created consequent to analyzing and mapping the activities of the enterprise. The structure of the created functional documents is selectively copied from the metadata files while the suitable content is inserted by the individual users. The documents are formatted such that a predefined partitioning scheme divides the document into functionally different segments. Each segment is utilized for a different use. The selective document-partitioning scheme enables the users to avoid “information overload” by being provided with the option of accessing only those parts of the documents that are necessary for the performance of a specific task. For example, when. an instructor teaches a new employee regarding the performance of a specific procedure the document is displayed in the “teaching mode” i.e., both the teaching layer and the basic performing layer will be accessed and displayed. Subsequent to the user's completion of the teaching stage, the teaching segment will not be displayed in order not to distract the user with the now needless information. The user selectively accesses segments of the document in accordance with a specifically pre-prepared checklist. During proper performance of the procedure the non-essential segments of the document are “hidden” from the user's view and only segments essential to the performance of the working process will be accessed and displayed. Related documents are linked by a predefined linking mechanism. Although the linking method is transparent to the users links can be created easily by the definition of specific connection points within the document. Fast access is provided within different segments of the same document and within a set of linked documents. Similar linking methods and access methods are provided to the manipulation of metadata objects such as content formats and procedure formats. As a result of keeping the documents in a common repository the documents are easily tracked, indexed, and manipulated. The proposed system and method provides close collaboration of the workforce within the organization by supporting asynchronous communication between the employees via the shared documents. The system and method also provides substantially effective management practices to managers functioning on the various levels of the organization such as executives, project leaders and the like. The system provides for close control, and ready follow-up of the progress of work associated with a standard process or a specific project within an organization by supporting the centralization and non-redundancy of the relevant enterprise knowledge. In the preferred embodiment of the present invention, a typical operative procedure comprises about twenty pages of text with an uncompressed size of about 1 Mbyte. Therefore, the utilization of the offered method and system effects substantial savings in the existing storage space. A medium-size or a large-size organization using the proposed system and method will have the capability of storing thousand of documents on-line. A substantial advantage provided by the present invention regards the simplicity of the operations involved. Unlike the currently offered management systems, the implementation of the system and method of the present invention does not necessitate the setting up of a distinct Procedure Department staffed by specifically trained personal, and dealing exclusively in the preparation of the procedures, within the organization. Using the method and system offered by. the present invention, following a short teaching period (days), practically any executive, team leader, project leader, or other employee will have the skill and the capability for preparing their own procedures. The present invention proposes a novel method for the management of organizations via a set of software tools that cover the entire range of management activities. The proposed method and system transform the intuitive “art of management” into a well-defined, technical, process comprising easy to understand, easy to learn systematic procedures. The method includes built-in and customizable management instruction and teaching procedures. A novel and creative process is provided for developing efficient, effective, and realistic procedures for working methods designed to achieve the dynamically changing objectives of an organization. The methods are created adaptively and interactively. The builders of the methods continuously respond to the changing conditions of a realistic environment in order to achieve dynamic objectives. Persons skilled in the art will appreciate that the present invention is not limited to what has been particularly shown and described hereinabove. Rather the scope of the present invention is defined only by the claims, which follow.

I claim:

1. A computer-based organization management method for establishing, integrating, distributing, sharing, and controlling information operative in the management of an organization, the method comprising the steps of:
generating at least one document template on a computer readable media for storage of at least one organized and formatted organization information unit concerning structure and functionality of an organization;
creating at least one procedure document based on the at least one organized and formatted organization information unit stored in the at least one document template established on the computer-readable media.

2. The method of claim 1. further comprising the step of establishing at least one working task table on the computer-readable media; and processing the at least one working task table.

3. The method of claim 2, wherein the at least one working task is associated with at least one procedure document.

4. The method of claim 1, wherein the organization management method further comprises the steps of:
accumulating the at least one organization information unit concerning the structure and the functionality of an organization; and
organizing and formatting the at least one organization information unit for storage on the computer readable media.

5. The method of claim 1, wherein the step of creating further comprises the steps of:
inserting procedure information into the procedure document;
verifying the procedure information in the procedure document;
distributing the procedure document for the intended users of the procedure;
instructing the intended users in the performance of the procedure;
performing the procedure by the intended users of the procedure;
analyzing the performance of the procedure by the intended users; and
authorizing the intended users for the activation of the procedure.

6. The method of claim 1, wherein the step of processing further comprises the steps of:
creating a task table including a list of tasks assigned to specific users of the system; and
distributing the at least one task to the users assigned for the performance of the specific working process; and
performing the working process; and
updating the procedure document with information corresponding to the execution of the working process; and
supervising the performance of the working process via interaction with the task table; and
delivering reminders to the users assigned to a working process concerning the timetable of the task.

7. In a computing environment including a computing platform having a processing unit, an input device, a display device, and a memory device, a computer-based organization management system comprising:
a management knowledge base containing management knowledge files comprising:
at least one knowledge document file for storing a series of tasks to which at least one user of the system is charged with;
at least one knowledge document definition file for defining the format of the at least one knowledge document file;
a management system containing a set of organization management modules executable by a computer comprising:
a content formatter module to provide structuring and formatting to at least one organization content file; and
a procedure formatter to provide structuring and formatting to the at least one procedure file; and
a reminder formatter to provide structuring and formatting to the at least one reminder; and
a reminder handler to handle reminders; and
a table builder to provide generic creation of tables; and
a form builder to provide generic form building; and
a text editor to provide for specialized text processing; and
a check list builder to provide for checklist document creation.

8. The system of claim 7 further comprising of the element of a task formatter to provide structuring and formatting to the at least one task file.

9. The system of claim 7, wherein the at least one knowledge document file comprises at least one procedure document to hold procedure building information and operative information.

10. The system of claim 7, wherein the at least one knowledge document definition file comprises;
at least one content format document to provide formatting information for the creation of at least one content document; and
at least one procedure format documents to provide format information for the creation of a procedure document.

11. The system of claim 7 further comprising at least one task table format associated with at least one procedure document.

12. The system of claim 7, wherein the at least one content format document comprises:
a subject identification associated with a management information unit; and
a subject description storing displayable and printable information concerning the specific subject; and
a pointer value to connect to a procedure document associated with the subject.

13. The system of claim 12, wherein the subjects are collected into specific subjects connected into clusters representing the progression of a user in the performance of predefined steps in the organization.

14. The system of claim 9, wherein the at least one procedure document comprises:
a procedure builder section; and
a users section to indicate the designated users of the procedure; and
an objectives section to define the objective and the direction of the procedure; and
an basic assumptions section comprising;
a know problems part; and
an options part; and
a conclusions part;
a working methods section to describe the working methods associated with the procedure; and
a control methods section to describe control methods associated with the procedure; and
a follow-up and distribution section to describe the changes made in procedure and to define the distribution lists for the users of the procedure.

15. The system of claim 14, wherein the procedure builder section comprises:
a basic layer to be used by the user responsible for the performance of the procedure; and
a teaching layer designed to be utilized by an instructor; and
an update layer designed to be used by the builder of the procedure document; and
a programming layer designed to be utilized by the software programmers as working areas and data structures.

16. The system of claim 15, wherein the teaching layer is utilized for the self-study process of a new user.

17. The system of claim 15, wherein the procedure builder section further comprise additional layers to be utilized according to the specific needs of a specific implementation.

18. The system of claim 11, wherein the at least one task table comprises:
a subject identification field to identify the specific subject associated with the task; and
a user identification field to identify the user to which the task is assigned to; and
a start date value field to define the starting date of the task; and
a target date value field to hold the assessed termination date for the task; and
a control flag indicating the delivery of the task to the user; and a control flag indicating completion of the task.

19. The system of claim 7, wherein the organization management system further comprises a word processing application providing comprehensive work processing capabilities to the users of the system.

20. The system of claim 7, wherein the organization management system further comprises an electronic mail application providing comprehensive electronic mail delivery capabilities to the users of the system.

21. The system of claim 19, wherein the word-processing application utilized is the “Word” application.

22. The system of claim 19, wherein the word-processing application is a specifically developed program product.

23. The system of claim 20, wherein the electronic mail application utilized is the “Outlook” application.

24. The system of claim 9, wherein the procedure document is partitioned into utilization specific segments corresponding to the document layers.

25. The system of claim 11, wherein the task table is a collection of task records defined and created by one or more users .

26. The system of claim 11, wherein the task records assigned to a specific intended user by an authorized user.

27. In a computing and communicating environment accommodating at least one client system connectable to a server system a computer-based organization management method for establishing, distributing, studying, sharing, maintaining and supervising document-based information functional to the management of an organization, the method comprising the steps of:
generating at least one content document on the computer readable media for the storage of the at least one structured and formatted organization information unit concerning the activities of the organization; and
building at least one procedure document based on the at least one structured and formatted organization information unit stored in the at least one knowledge document established on the computer-readable media.

28. The method of claim 27 further comprising the steps of:
establishing at least one task table on the computer-readable media which at least one task table is associated with the at least one task; and
interactively, controllably, and collaboratively processing the at least one task table.

29. The method of claim 28, wherein the organization management method further comprises the steps of:
analyzing the structure and functionality of the organization; and
collecting the data derived form the analysis of the organization into an aggregate of at least one information unit; and
structuring and formatting the at least one organization information unit for storage on a computer readable media; and
mapping the at least one information unit into the at least one content document stored on the computer readable media.

30. The method of claim 28, wherein the step of building further comprises the steps of:
updating the procedure document with relevant procedure information; and
verifying the procedure information in the procedure document; and
distributing the procedure document to the potential users of the procedure; and
instructing the potential users in the performance of the procedure; and
controllably performing the procedure by the potential users of the procedure; and
analyzing and evaluating the performance of the procedure by the users; and
authorizing the users for the activation of the procedure.

31. The method of claim 28, wherein the step of processing further comprises the steps of:
creating a task table including a list of tasks assigned to specific users of the system; and
distributing the at least one task to the users assigned for the performance of the specific task; and
performing the working procedure; and
updating the procedure document with information corresponding in the execution of the working procedure; and
supervising the performance of the working procedure via interaction with the procedure document; and
delivering reminders to the users assigned to a task concerning the timetable associated with the task.
